(19) United States
(12) Patent Application Publication
(10) Pub. No.: US 2004/0241423 A1
(43) Pub. Date: Dec. 2, 2004

(54) Nail make-up composition with a mirror effect

(76) Inventors: Roland Ramin, Paris (FR); Roberto Cavazzuti, Paris (FR)

Correspondence Address: Thomas L. Irving, FINNEGAN, HENDERSON, FARABOW,, GARRETT & DUNNER, L.L.P., 1300 I Street, N.W., Washington, DC, 20005-3315, US

(21) Appl. No.: 10/796,987

(22) Filed: Mar. 11, 2004

Related U.S. Application Data
(60) Provisional application No. 60/455,865, filed on Mar. 20, 2003.

(30) Foreign Application Priority Data
Mar. 11, 2003 (FR) 03 03003

(51) Int. Cl. B32B 9/04

(52) U.S. Cl. 428/323; 427/180; 428/328; 428/446

(57) ABSTRACT

The present invention relates to a composition for making up the nails, characterized in that it comprises, in a physiologically acceptable medium, particles with a metallic glint in a proportion of greater than or equal to 2% by weight, with respect to the total weight of the composition, and at least one texturizing agent or a mixture of texturizing agents in a proportion of less than or equal to 15% by weight, with respect to the total weight of the composition.

The present invention relates to a composition for making up the nails using particles with a metallic glint making it possible to obtain a mirror effect. This invention also relates to a kit for making up the nails for the purpose of obtaining a make-up with a mirror effect. The present invention additionally relates to the corresponding make-up methods.

The use of metal particles has already been described in various types of cosmetic make-up compositions. Thus, Patent Application EP 1 082 952 discloses make-up compositions, in particular for the nails, comprising glass particles covered with a metal layer making it possible to obtain a make-up exhibiting a sparkling and wear-resistant metallic appearance. Patent Application EP 953 330 also discloses the combination of two different compositions respectively comprising metal particles of goniochromatic pigment type and a pigment of conventional type having one of the colours of the first pigment for the production of a make-up with a metallic effect which can vary according to the angle of observation and which exhibits iridescent effects.

More recently, International Patent Application WO 02/03913 discloses nail varnish compositions comprising particles in the form of aluminium platelets in proportions by weight of 0.4 to 0.75% and film-forming agents having high molecular weights for the production of a make-up of mirror type, that is to say, in this instance, a make-up having not only the colour of aluminium but also a glossiness and an ability to reflect the separate elements of an object.

The inventors have discovered that it is possible to obtain make-ups exhibiting a mirror effect which is improved with respect to those obtained in the prior art by using liquid compositions, of low viscosity, with a reduced content of texturizing agents and with a high content of particles with a metallic glint.

The present invention relates, according to a first aspect, to a composition for making up the nails, in particular for a make-up with a mirror effect, comprising, in a physiologically acceptable medium, particles with a metallic glint in a proportion of greater than or equal to 2% by weight, with respect to the total weight of the composition, and at least one texturizing agent or a mixture of texturizing agents in a proportion of less than or equal to 15% by weight, with respect to the total weight of the composition.

The present invention relates, according to a second aspect, to a composition for making up the nails comprising, in a physiologically acceptable medium, particles with a metallic glint, said composition being capable of forming a film for which the wear resistance, expressed by the loss in weight, measured according to Standard AFNOR NF T30-015, is greater than 5% by weight, in particular greater than 10% by weight and more particularly greater than 15% by weight.

The present invention relates, according to a third aspect, to the use of a composition as defined above for forming a base coat in a multilayer make-up.

The present invention relates, according to a fourth aspect, to a kit for making up the nails comprising, in separate containers, a first composition comprising, in a first physiologically acceptable medium, particles with a metallic glint in a proportion of greater than or equal to 2% by weight, with respect to the total weight of the first composition, and a second composition, different from the first composition, comprising, in a second physiologically acceptable medium, at least 10% by weight, with respect to the total weight of the second composition, of at least one film-forming agent.

The present invention relates, according to a fifth aspect, to a kit for making up the nails comprising, in separate containers, a first composition comprising, in a first physiologically acceptable medium, particles with a metallic glint, the said first composition being capable of forming a film for which the wear resistance, expressed as loss in weight, measured according to Standard AFNOR NF T30-015, is greater than 5% by weight, in particular greater than 10% and more particularly greater than 15% by weight, and a second composition, different from the first composition, comprising, in a second physiologically acceptable medium, at least 10% by weight, with respect to the weight of the second composition, of at least one film-forming agent.

The present invention relates, according to a sixth aspect, to a method for making up the nails comprising the application, to all or part of the surface to be made up, of at least one layer of a composition for making up the nails as defined above.

The present invention relates, according to a seventh aspect, to a method for making up the nails comprising the application, to the surface to be made up, of at least one layer of each of the compositions of a kit as defined above.

The present invention relates, according to an eighth aspect, to a made-up synthetic support comprising a make-up which might be obtained by the method of the invention.

Mirror Effect

As specified above, the “mirror” effect is distinguished in particular from a simple metallic effect by its ability to at least partially reflect the separate elements of an object.

More specifically, within the meaning of the invention, the term “make-up with a mirror effect” denotes a make-up which exhibits an intense specular reflection.

In this instance, the films obtained with the compositions according to the invention are particularly advantageous in terms of light reflection. This light reflection can, if appropriate, be assessed according to the following test:

A layer with a thickness of 150 μm of the test composition (before drying) is deposited on a sheet of glass and then drying is allowed to take place for 24 hours at ambient temperature. The light-reflecting properties of the film obtained are then determined.

In particular, the percentage of reflectance can be measured using a spectrocolorimeter. For example, for a perfect mirror (silvered glass method), the value is close to 100%. For a conventional nail varnish formulation with a metallic effect, the maximum value is 45%. For the desired “mirror” effect, the value is at least equal to 50%.

In this instance, the compositions according to the invention are capable of forming a film having a percentage of reflectance at least equal to 50%, in particular greater than or equal to 70%.

The compositions according to the invention are generally fluid, that is to say of low viscosity.

The expression “liquid compositions of low viscosity” denotes compositions generally exhibiting a dynamic viscosity, at 25° C. and at atmospheric pressure, of the order of 30 to 250 Pa.s, in particular of 50 to 150 Pa.s, measured using a Brookfield type LV II viscometer.

The fact of formulating the particles with a metallic glint in a composition of low viscosity is probably favourable to the physical arrangement of these particles at the time of their application to the make-up support and in particular favours the achievement of a homogeneous and continuous distribution of the said particles, resulting in an improved mirror effect.

Wear Resistance

Furthermore, when the composition of the invention is applied to a support, it is possible to obtain, after evaporation of the volatile compounds, a base coat of a film and in particular of a thin film. It is thus possible to obtain a film having a thickness ranging from 0.5 to 30 μm.

The film thus obtained exhibits a low wear resistance.

The resistance of the film which can be obtained with the compositions according to the invention can be measured in particular according to Standard AFNOR NF T30-015, the principle of which is restated below.

The test composition is applied to a disc in the form of a layer with a thickness of 600 μm (before drying) and then drying is allowed to take place at 30° C. for one hour. The film of varnish deposited on the disc is subsequently brought into contact for one hour with abrasive discs (Taber abrasion tester), the disc having a rotational speed of one revolution per second. After one hour, the disc is weighed and the loss in weight LW of product, expressed as percentage of the weight lost with respect to the initial weight, is calculated.

Consequently, in this test, the greater the loss in weight, the greater the percentage of weight lost and the lower the wear resistance of the composition.

The film obtained with the composition of the invention exhibits a wear resistance, expressed as loss in weight measured according to Standard AFNOR NF T 30-015, generally of greater than 5%, in particular of greater than 10% and more particularly of greater than 15% by weight.

According to a specific embodiment, the composition of the invention capable of forming a film exhibiting such a wear resistance comprises, in a physiologically acceptable medium, particles with a metallic glint in a proportion of greater than or equal to 2% by weight with respect to the total weight of the composition.

This composition can comprise at least one texturizing agent or a mixture of texturizing agents in a proportion of less than or equal to 15% by weight with respect to the total weight of the composition.

The Texturizing Agents

The term “texturizing agent” is understood to denote, in the context of the present invention, any organic compound which acts mainly or secondarily on the rheology of the composition according to the invention.

In this instance, it may be a matter of conventional thickening agents, such as fillers, for example clays, pyrogenic silicas, hydrogenated castor oils, polyamides or cellulose derivatives, and/or of film-forming agents, such as cellulose derivatives in the form of cellulose polymers (nitrocelluloses, cellulose acetate butyrates, cellulose esters and cellulose ethers), and/or of resins and/or of additional agents which are able to form a film.

The film-forming agents are mainly intended to facilitate the application of the composition and to provide for the formation of a film while nevertheless making it possible to obtain a liquid composition of low viscosity.

The composition of the present invention is characterized in particular by its low proportion of texturizing agents. The total proportion of texturizing agents is generally less than or equal to 15% by weight and in particular less than or equal to 10% by weight, with respect to the total weight of the composition.

This proportion is generally greater than or equal to 2% by weight and in particular greater than or equal to 5% by weight, with respect to the total weight of the composition.

The texturizing agents used in the compositions according to the invention are chosen in particular from film-forming agents, resins, additional agents which are able to form a film, thickening agents and their mixtures.

The Film-Forming Agents

The film-forming agents comprise in particular film-forming polymers.

The term “film-forming polymer” denotes a polymer capable of forming, by itself alone or in the presence of an additional agent which is able to form a film, an isolable film, in particular a film which is continuous and which adheres to a support, in particular to keratinous substances.

In the composition, use may be made of a single film-forming polymer or of a blend of film-forming polymers. This film-forming polymer can be chosen from the group consisting of radical polymers, polycondensates and polymers of natural origin.

The film-forming polymer can be organic or inorganic.

According to a first alternative form of the invention, the organic film-forming polymer is at least one polymer chosen from the group consisting of: film-forming polymers which are soluble or dispersible in at least one category of organic solvents, such as, for example, ketones, alcohols, glycols, propylene glycol ethers, short-chain esters, alkanes and their mixtures.

The corresponding polymers can be of any chemical nature. In particular, they can result either from the homo- or copolymerization of unsaturated monomers, or from polycondensation, or from the modification of natural polymers, in particular of polysaccharides. The weight-average molecular masses (Mw) of these polymers can vary from 3 000 to 1 000 000, in particular from 5 000 to 800 000 and especially from 10 000 to 500 000.

The following polymers are very particularly suitable among polymers which are soluble or dispersible in organic solvents:

a) (meth)acrylic acid ester and/or amide homo- and copolymers, in particular the polymers resulting from the polymerization or copolymerization of methyl, ethyl, propyl, butyl, isobutyl, tert-butyl, pentyl, hexyl, cyclohexyl, 2-ethylhexyl, heptyl, octyl, isobornyl, norbornyl or adamantyl acrylates and/or methacrylates or the corresponding (meth)acrylamides. These polymers will preferably comprise from 0 to 20% of a polar comonomer, such as (meth)acrylic acid, (meth)acrylamide, hydroxyethyl (meth)acrylate, 2-hydroxypropyl (meth)acrylate and (meth)acrylonitrile. They can also result from copolymerization with styrene or a substituted styrene.

b) Vinyl ester or amide homo- and copolymers, in particular the homo- and copolymers resulting from the polymerization of vinyl acetate, vinyl propionate or vinyl versatate, with or without the presence of a polar comonomer, such as crotonic acid, allyloxyacetic acid, maleic anhydride (or acid), itaconic anhydride (or acid), vinylacetamide and vinylformamide. Likewise, they can result from the copolymerization of at least one of the monomers mentioned with styrene or a substituted styrene.

c) Celluloses and cellulose derivatives, such as nitrocelluloses and/or cellulose esters, for example cellulose acetates, cellulose propionates, cellulose butyrates, cellulose acetate propionates and cellulose acetate butyrates.

d) Polycondensates which are soluble or dispersible in these solvents. They are generally used as main film-forming agent or else as co-film-forming agent for one of the categories of polymers mentioned above (a to c), in particular if they are of low molecular weight (Mw<20 000). They can be chosen from the following polymers or copolymers: polyurethanes, acrylic polyurethanes, polyureas, polyurea polyurethanes, polyester polyurethanes, polyether polyurethanes, polyesters, polyesteramides, polyesters with a fatty chain, epoxys and arylsulphonamide condensates, in particular tosylamide/formaldehyde condensates.

Mention may more particularly be made, among these polycondensates, in particular if they are used as film-forming agent or co-film-forming agent for one or more nitrocelluloses and/or for a cellulose ester (category c), of:

polyesters, in particular polyesters with a fatty chain and more particularly copolymers with the CTFA name: “phthalic anhydride/glycerol/glycidyl decanoate copolymer” and “adipic acid/neopentyl glycol/trimellitic anhydride copolymer”,

alkyds,

tosylamide/formaldehyde condensates,

polyurethanes and polyurea-urethanes,

acrylic resins,

silicone resins (non volatile or partially volatile).

According to a second alternative form of the invention, the, or at least one, film-forming polymer can be chosen from aqueous dispersions of polymer particles or film-forming latexes and, in this case, the composition according to the invention comprises at least one aqueous phase.

The aqueous dispersion comprising one or more film-forming polymers can be prepared by a person skilled in the art on the basis of his general knowledge, in particular by emulsion polymerization or by dispersing the polymer formed beforehand.

Mention may be made, among the film-forming polymers of this type which can be used in the composition according to the present invention, of synthetic polymers, of polycondensate type or of radical type, polymers of natural origin, and their blends.

Use may in particular be made, but in the latex form, of the polymers (homo- and copolymers) which are mentioned above as polymers which are soluble or dispersible in an organic solvent medium and more particularly of the polymers of categories a, b and c.

Mention may thus be made, among polycondensates, of anionic, cationic, non-ionic or amphoteric polyurethanes, of polyurethane-acrylics, of polyurethane-polyvinylpyrrolidones, of polyester-polyurethanes, of polyether-polyurethanes, of polyureas, of polyurea-polyurethanes and of their blends.

Mention may also be made of polyesters, polyesteramides, polyesters with a fatty chain, polyamides and epoxy ester resins.

The polyesters can be obtained, in a known way, by polycondensation of aliphatic or aromatic diacids with aliphatic or aromatic diols or with polyols. Use may be made, as aliphatic diacids, of succinic acid, glutaric acid, adipic acid, pimelic acid, suberic acid or sebacic acid. Use may be made, as aromatic diacids, of terephthalic acid or isophthalic acid, or alternatively of a derivative, such as phthalic anhydride. Use may be made, as aliphatic diols, of ethylene glycol, propylene glycol, diethylene glycol, neopentyl glycol, cyclohexanedimethanol or 4,4′-(1-methylpropylidene)bisphenol. Use may be made, as polyols, of glycerol, pentaerythritol, sorbitol or trimethylolpropane.

The polymers of radical type can in particular be acrylic and/or vinyl polymers or copolymers. Use is preferably made of anionic radical polymers. Mention may be made, as monomer carrying an anionic group which can be used during the radical polymerization, of acrylic acid, methacrylic acid, crotonic acid, maleic anhydride or 2-acrylamido-2-methylpropanesulphonic acid.

The acrylic polymers can result from the copolymerization of monomers chosen from esters and/or amides of acrylic acid or of methacrylic acid. Mention may be made, as example of monomers of ester type, of methyl methacrylate, ethyl methacrylate, butyl methacrylate, isobutyl methacrylate, 2-ethylhexyl methacrylate or lauryl methacrylate. Mention may be made, as example of monomers of amide type, of N-(t-butyl)acrylamide and N-(t-octyl)acrylamide.

The vinyl polymers can result from the homopolymerization or from the copolymerization of monomers chosen from vinyl esters, styrene or butadiene. Mention may be made, as example of vinyl esters, of vinyl acetate, vinyl neodecanoate, vinyl pivalate, vinyl benzoate and vinyl t-butylbenzoate.

Use may also be made of acrylic/silicone copolymers or nitrocellulose/acrylic copolymers.

Mention may also be made of the polymers resulting from the radical polymerization of one or more radical monomers inside and/or partially on the surface of pre-existing particles of at least one polymer chosen from the group consisting of polyurethanes, polyureas, polyesters, polyesteramides and/or alkyds. These polymers are generally referred to as hybrid polymers.

The dispersion can also comprise an associative polymer of polyurethane type or a natural gum, such as xanthan gum.

Mention may be made, as polymer in aqueous dispersion, of the dispersions of acrylic polymers sold under the names Neocryl XK-90®, Neocryl A-1070®, Neocryl A-1090®, Neocryl BT-62®, Neocryl A-1079® or Neocryl A-523® by Zeneca or Dow Latex 432® by Dow Chemical. Use may also be made of aqueous polyurethane dispersions and in particular the polyester-polyurethanes sold under the names “Avalure UR-405®”, “Avalure UR-410®”, “Avalure UR-425®” or “Sancure 2060®” by Goodrich and the polyether-polyurethanes sold under the names “Sancure 878®” by Goodrich or “Neorez R-970®” by Avecia.

According to a third alternative form of the invention, the film-forming polymer can be chosen from water-soluble or water-dispersible polymers and, in this case, the composition according to the invention comprises at least one aqueous phase.

Mention may be made, as water-dispersible polymers, of water-dispersible polycondensates with sulphonate functional groups, such as copolyesters composed of units deriving from isophthalic acid, from the sodium salt of sulphoisophthalic acid, from diethylene glycol and from 1,4-cyclohexanedimethanol, these being present in particular in proportions of 89/11/78/22 or of 82/18/54/46. These polycondensates are sold under the names of “AQ 38/” and “AQ 55/” respectively by Eastman Kodak.

Mention may be made, as water-soluble polymers, of water-soluble copolymers with carboxylic acid functional groups (synthetic polymers) which are preferably chosen from:

a) polyoxyethylenated crotonic acid/vinyl acetate copolymers,

b) N-octylacrylamide/methyl methacrylate/hydroxypropyl methacrylate/acrylic acid/tert-butylaminoethyl methacrylate copolymers,

c) alternating methyl vinyl ether/maleic anhydride copolymers monoesterified by butanol,

d) acrylic acid/ethyl acrylate/N-(tert-butyl)acrylamide terpolymers, and

e) vinyl acetate/crotonic acid copolymers, vinyl acetate/crotonic acid/vinyl neodecanoate terpolymers, vinyl 4-(tert-butyl)benzoate and their blends.

Of course, the choice of the type(s) of film-forming polymer(s) used will depend on the type of physiologically acceptable medium chosen for the composition.

In the composition, the content of film-forming polymer(s) can vary from 0.1% to 15% by weight, in particular from 5% to 10% by weight, and can in particular be less than or equal to 7% by weight, with respect to the total weight of the composition.

Additional Agent Which is Able to Form a Film

The additional agent which is able to form a film can be chosen from any compound known to a person skilled in the art as being capable of fulfilling the desired function and can be chosen in particular from plasticizers and coalescents for the film-forming polymer.

Mention may in particular be made, alone or as a mixture, of conventional plasticizers or coalescents, such as:

glycols and their derivatives, such as diethylene glycol ethyl ether, diethylene glycol methyl ether, diethylene glycol butyl ether, diethylene glycol hexyl ether, ethylene glycol ethyl ether, ethylene glycol butyl ether or ethylene glycol hexyl ether,

glycol esters,

propylene glycol derivatives and in particular propylene glycol phenyl ether, propylene glycol diacetate, dipropylene glycol butyl ether, tripropylene glycol butyl ether, propylene glycol methyl ether, dipropylene glycol ethyl ether, tripropylene glycol methyl ether, diethylene glycol methyl ether or propylene glycol butyl ether,

esters of acids, in particular carboxylic acids, such as citrates, in particular triethyl citrate, tributyl citrate, triethyl acetylcitrate, tributyl acetylcitrate or tri(2-ethylhexyl) acetylcitrate; phthalates, in particular diethyl phthalate, dibutyl phthalate, dioctyl phthalate, dipentyl phthalate or dimethoxyethyl phthalate; phosphates, in particular tricresyl phosphate, tributyl phosphate, triphenyl phosphate or tributoxyethyl phosphate; tartrates, in particular dibutyl tartrate; adipates; carbonates; sebacates; benzyl benzoate; butyl acetylricinoleate; glyceryl acetylricinoleate; butyl glycolate; camphor; glyceryl triacetate; or N-ethyl-o,p-toluenesulphonamide,

oxyethylenated derivatives, such as oxyethylenated oils, in particular vegetable oils, such as castor oil; or silicone oils,

their mixtures.

The type and the amount of plasticizer and/or coalescent can be chosen by a person skilled in the art on the basis of his general knowledge, so as to obtain a composition having cosmetically acceptable properties, with the proviso, of course, that the total amount of texturizing agent does not exceed that indicated above and that the said composition retains its characteristic of fluidity and/or of ability to form a film having a low wear resistance.

For example, the content of plasticizer and/or of coalescent can range from 0.01% to 10% and in particular from 1% to 3% by weight with respect to the total weight of the composition.

Thickening Agent

The thickening agent can in particular be a thickener for a non-aqueous phase and can be chosen from: hydrophobic silicas, such as those disclosed in document EP-A-898 960 and, for example, sold under the references “Aerosil R812®” by Degussa; “Cab-O-Sil TS-530®”, “Cab-O-Sil TS-610®” or “Cab-O-Sil TS-720®” by Cabot or “Aerosil R972®” or “Aerosil R974®” by Degussa; clays, such as montmorillonite, or modified clays, such as bentones, for example stearalkonium hectorite or stearalkonium bentonite, or polysaccharide alkyl ethers (in particular where the alkyl group comprises from 1 to 24 carbon atoms, preferably from 1 to 10, better still from 1 to 6 and more especially from 1 to 3), such as those disclosed in the document EP-A-898 958.

The thickening agent can also be a thickener for an aqueous phase, such as, for example, an aqueous gelling polymer and/or clay.

The choice of these thickening agents is, of course, made while taking into account the nature of the physiologically acceptable medium.

The total proportion of thickening agent(s) in the compositions according to the invention is generally less than or equal to 5%, in particular less than or equal to 2% and especially less than or equal to 1% by weight, with respect to the total weight of the composition.

The choice of the texturizing agents used in the composition according to the invention is, of course, made while taking into account the nature of the physiologically acceptable medium of the composition.

The Particles with a Metallic Glint

The term “particles with a metallic glint” denotes particles where the nature, size, structure and surface condition of the particles allow them to reflect the incident light, in particular in a non-iridescent way.

The particles with a metallic glint which can be used in the compositions according to the invention are chosen in particular from:

particles of at least one metal and/or of at least one metal derivative,

particles comprising a monomaterial or multimaterial and organic or inorganic substrate at least partially covered with at least one layer with a metallic glint comprising at least one metal and/or at least one metal derivative, and

mixtures of the said particles.

Mention may be made, among the metals which can be present in the said particles, of, for example, Ag, Au, Cu, Al, Ni, Sn, Mg, Cr, Mo, Ti, Zr, Pt, Va, Rb, W, Zn, Ge, Te, Se and their mixtures or alloys. Ag, Au, Cu, Al, Zn, Ni, Mo, Cr and their mixtures or alloys (for example bronzes and brasses) are preferred metals.

The term “metal derivatives” denotes compounds derived from metals, in particular oxides, fluorides, chlorides and sulphides.

Mention may in particular be made, among the metal derivatives which can be present in the said particles, of metal oxides, such as, for example, titanium oxides, in particular TiO₂, iron oxides, in particular Fe₂O₃, tin oxides or chromium oxides, and the following compounds: MgF₂, TiCl₄, CrF₃, ZnS, ZnSe, Al₂O₃, MgO, SeO₃, ZrO₂, MoS₂ and their mixtures or alloys.

According to a first alternative form, the particles with a metallic glint are composed of at least one metal as defined above, of at least one metal derivative as defined above or of their mixture.

These particles can be at least partially covered by a layer of another material, for example of transparent material, such as, in particular, rosin, silica, stearates, polysiloxanes, polyester resins, epoxide resins, polyurethane resins and acrylic resins.

Mention may be made, by way of illustration of these particles, of aluminium particles, such as those sold under the names Starbrite 1200 EAC® by Siberline and Metalure® by Eckart.

Mention may also be made of metal powders formed from copper or from alloy mixtures, such as the references 2844 sold by Radium Bronze, metal pigments, such as aluminium or bronze, for example those sold under the names Rotosafe 700 from Eckart, aluminium particles coated with silica sold under the name Visionaire Bright Silver from Eckart, and particles of metal alloy, such as powders formed from bronze (copper and zinc alloy), coated with silica, which are sold under the name Visionaire Bright Natural Gold® from Eckart.

According to a second alternative form, the particles with a metallic glint are particles which comprise a substrate and which therefore exhibit a multilayer structure, for example a two-layer structure. This substrate can be organic or inorganic, natural or synthetic, monomaterial or multimaterial, or solid or hollow. When the substrate is synthetic, it can be produced with a shape favouring the formation of a reflective surface after coating, in particular after the deposition of a layer of materials with a metallic glint. The substrate can, for example, exhibit a flat surface and the layer of materials with a metallic glint a substantially uniform thickness.

The substrate can in particular be chosen from metals and metal derivatives as mentioned above and also from glasses, ceramics, aluminas, silicas, silicates, in particular aluminosilicates and borosilicates, synthetic mica, such as fluorophlogopite, and their mixtures, this list not being limiting.

The layer with a metallic glint can entirely or partially coat the substrate and this layer can be at least partially covered by a layer of another material, for example a transparent material, in particular as mentioned above. According to a specific embodiment, the layer with a metallic glint entirely coats the substrate, directly or indirectly, that is to say with interposition of at least one metal or non-metal intermediate layer.

The metals or metal derivatives which can be used in the layer with a metallic glint are as defined above.

Glass particles covered with a metal layer are disclosed in particular in the documents JP-A-09188830, JP-A-10158450, JP-A-10158541, JP-A-07258460 and JP-A-05017710.

Mention may be made, by way of illustration of these particles comprising a glass substrate, of those coated respectively with silver, with gold or with titanium, in the form of platelets, sold by Nippon Sheet Glass under the names Microglass Metashine®, or those coated either with brown iron oxide, on the one hand, or with titanium oxide, with tin oxide or with one of their mixtures, on the other hand, such as those sold under the name Reflecks® by Engelhard or those sold under the reference Metashine® MC 2080GP® by Nippon Sheet Glass.

These glass particles covered with metals can be coated with silica, such as those sold under the name Metashine® series PSS1 or GPS1 by Nippon Sheet Glass.

Mention may also be made, among the particles with a metallic glint comprising a substrate which can be used in the compositions according to the invention, of particles with interferential multilayers.

Examples of a multilayer structure comprising a metal layer which can be used in compositions produced in accordance with the invention are, for example, the following structures: Al/SiO₂/Al/SiO₂/Al, particles having this structure being sold by Dupont de Nemours; Cr/MgF₂/Al/MgF₂/Cr, particles having this structure being sold under the name of Chromaflair® by Flex; MoS₂/SiO₂/Al/SiO₂/MoS₂; Fe₂O₃/SiO₂/Al/SiO₂/Fe₂O₃ and Fe₂O₃/SiO₂/Fe₂O₃/SiO₂/Fe₂O₃, particles having this structure being sold under the name of Sicopearl® by BASF; or MoS₂/SiO₂/mica-oxide/SiO₂/MoS₂; Fe₂O₃/SiO₂/mica-oxide/SiO₂/Fe₂O₃; TiO₂/SiO₂/TiO₂ and TiO₂/Al₂O₃/TiO₂, particles having these structures being sold under the name Xirona® by Merck (Darmstadt).

The particles with a metallic glint used in the compositions according to the invention can exhibit varied shapes. They can in particular be flat. The term “flat particles” denotes particles with a surface which exhibits substantially no bumps and no unevenness and which exhibit only a slight curvature, indeed even no curvature.

These particles can in particular exist in the form of platelets. The term “platelets” denotes particles for which the ratio of the greatest dimension to the smallest dimension, known as the shape factor, is greater than or equal to 5.

The term “dimensions” denotes the dimensions given by the random particle size distribution of half the population, referred to as D50.

The particles with a metallic glint have in particular a shape factor of greater than or equal to 8 and in particular of greater than or equal to 10, for example of greater than or equal to 15.

The particles with a metallic glint used in the compositions according to the invention have, for example, according to their greatest dimension, a mean size of less than or equal to 25 μm, in particular of less than or equal to 10 μm, and especially of approximately 6 μm.

The term “mean size” denotes the dimension given by the random particle size distribution of half the population, referred to as D50.

The said particles generally have a thickness of less than or equal to 1 μm, in particular of less than or equal to 0.7 μm, in particular of less than or equal to 0.5 μm.

The total proportion of particles with a metallic glint is generally greater than or equal to 2%, in particular greater than or equal to 3%, especially greater than or equal to 5% and more particularly greater than or equal to 7% by weight with respect to the total weight of the composition. The total proportion of particles with a metallic glint is in particular less than or equal to 70%, especially less than or equal to 20% by weight and more particularly less than or equal to 10% by weight with respect to the total weight of the composition.

Physiologically Acceptable Medium

The composition according to the invention additionally comprises a physiologically acceptable medium. This term denotes a non-toxic medium capable in particular of being applied to the superficial body growths of human beings.

This medium can be of organic solvent, aqueous solvent or mixed solvent type.

The physiologically acceptable medium of the composition generally comprises at least one volatile solvent. The volatile solvent can be chosen in particular from volatile organic solvents, water and their mixtures.

Organic Solvents

The composition according to the invention can comprise at least one organic solvent medium constituting an organic phase composed of at least one organic solvent which is volatile at ambient temperature.

Mention may be made, as organic solvent which is volatile or non-volatile at ambient temperature, of:

ketones which are liquid at ambient temperature, such as methyl ethyl ketone, methyl isobutyl ketone, diisobutyl ketone, isophorone, cyclohexanone and acetone;

alcohols which are liquid at ambient temperature, such as ethanol, isopropanol, butanol, diacetone alcohol, 2-butoxyethanol and cyclohexanol;

glycols which are liquid at ambient temperature, such as ethylene glycol, propylene glycol, pentylene glycol and glycerol;

propylene glycol ethers which are liquid at ambient temperature, such as propylene glycol monomethyl ether, propylene glycol monomethyl ether acetate and dipropylene glycol mono(n-butyl) ether;

short-chain esters (having a total of 3 to 8 carbon atoms), such as methyl acetate, ethyl acetate, propyl acetate, n-butyl acetate, and isopentyl acetate or aryl acetate;

alkanes which are liquid at ambient temperature, such as decane, heptane, octane, dodecane, cyclohexane and isododecane;

aldehydes which are liquid at ambient temperature, such as benzaldehyde and acetaldehyde, and

their mixtures.

The solvent is chosen in particular from short-chain esters (having a total of 3 to 8 carbon atoms), alcohols which are liquid at ambient temperature, and their mixtures.

The composition according to the invention can also comprise one or more silicone oils, generally in a small amount, that is to say which can be less than 10% by weight of the solvent phase. They can in particular be volatile or non-volatile oils, such as dimethicones, phenyl dimethicones, alkyl dimethicones, dimethicone copolyols or cyclomethicones.

When the physiologically acceptable medium comprises a significant amount of organic phase, the latter can be present in a proportion varying from 30 to 97% by weight and in particular ranging from 50 to 95% by weight with respect to the total weight of the composition.

Aqueous Phase

The composition according to the invention can also comprise at least one aqueous medium, constituting an aqueous phase, which can form the continuous phase of the composition.

The aqueous phase can be composed essentially of water; it can also comprise a mixture of water and of water-miscible organic solvent(s) (miscibility in water of greater than 50% by weight at 25° C.), such as lower monoalcohols having from 1 to 5 carbon atoms, for example ethanol or isopropanol, glycols having from 2 to 8 carbon atoms, such as propylene glycol, ethylene glycol, 1,3-butylene glycol or dipropylene glycol, C₃-C₄ ketones or C₂-C₄ aldehydes.

The aqueous phase (water and optionally water-miscible organic solvent) can be present in a proportion varying from 30 to 97% by weight, in particular ranging from 50 to 80% by weight, with respect to the total weight of the composition.

Additives

The compositions according to the invention can additionally comprise at least one additive, in particular an additional colouring material chosen from natural or synthetic pearlescent agents, non-metallic pigments, non-metallic particles (having as support, for example: glass, polyacrylate, polyurethane or poly(butylene terephthalate)), natural or synthetic fibres and water-soluble or fat-soluble dyes.

The composition for making up the nails according to the invention is more particularly a nail varnish composition. This composition can be applied to natural or synthetic nails, such as false nails.

Another subject-matter of the present invention is the use of a composition as defined above to form a base coat in a multilayer make-up.

Make-Up Kit

A further subject-matter of the present invention is a kit for making up the nails, which, according to a first alternative form, comprises, in separate containers, a first composition comprising, in a first physiologically acceptable medium, particles with a metallic glint in a proportion of greater than or equal to 2% by weight and in particular of greater than 3% by weight, with respect to the total weight of the first composition, and a second composition, different from the first composition, comprising, in a second physiologically acceptable medium, at least 10% by weight, with respect to the total weight of the said second composition, of at least one film-forming agent.

According to a second alternative form, a subject-matter of the invention is a kit for making up the nails which comprises, in separate containers, a first composition comprising, in a first physiologically acceptable medium, particles with a metallic glint, the said first composition being capable of forming a film for which the wear resistance, measured according to Standard AFNOR NF T30-015, is greater than 5% by weight, in particular greater than 10% by weight and more particularly greater than 15% by weight, and a second composition, different from the first composition, comprising, in a physiologically acceptable medium, at least 10% by weight, with respect to the weight of the second composition, of at least one film-forming agent.

Whatever the alternative form of the kit envisaged, the first composition can be a composition for making up the nails as defined above.

The second composition of the kit can, according to a specific embodiment, comprise at least 15% by weight, with respect to the total weight of the second composition, of film-forming agent(s).

They are conventional film-forming agents and more particularly film-forming polymers which are soluble or dispersible in organic solvents or they are film-forming latexes, in particular as described above. The choice of these film-forming agents is also made according to the nature of the physiologically acceptable medium of these second compositions. The second compositions of the kit of the invention can also comprise at least one additional agent which is able to form a film, such as those described above.

The plasticizer and/or coalescent can be present in the composition in a content ranging from 0.01 to 15% by weight, in particular from 2 to 7% by weight, with respect to the total weight of the composition.

The second composition can additionally comprise at least one conventional thickening agent chosen in particular from those described above.

The proportion of thickening agent(s) present in the second composition can range from 0.01 to 3%₀.

The physiologically acceptable medium of the second composition of the invention is, as for that of the first composition, a non-toxic medium capable in particular of being applied to the superficial body growths of human beings. This medium can be of organic, aqueous or mixed type. It generally comprises at least one volatile solvent which can be chosen in particular from volatile organic solvents, water and their mixtures.

Mention may be made, as example of solvents which can be used in the said second composition, of those described above.

However, of course, a person skilled in the art will take care to choose this second physiologically acceptable medium so that the application of the second composition to the film capable of being generated by the application of the first composition and then drying does not affect the said film and in particular does not dissolve it or does not dilute it.

The aqueous phase (water and optionally the water-miscible organic solvent), the organic phase or the sum of these two phases can be present in a total content of between 1 and 90% by weight, in particular ranging from 5 to 60% by weight and especially ranging from 15 to 40% by weight, with respect to the total weight of the said second composition.

The second composition must not obstruct the expression of the desired mirror effect.

Generally, the second composition of the kit according to the invention is translucent, semi-transparent or transparent.

They can also be described as bulk translucent or transparent. This property of bulk transparency or translucency means that a layer with a thickness arbitrarily set at 1 cm allows a portion of the visible light to pass, either while scattering it (bulk translucent compositions) or without scattering it (bulk transparent compositions). In this case, the optical density is measured by using quartz cells with a thickness of 10 mm. The value of the optical density must be less than 1.

The second composition can also comprise a colouring material which can be chosen from dyes which are soluble in the said second physiologically acceptable medium and optionally pulverulent compounds.

The dyes are, for example, Sudan red, DC Red 17, DC Green 6, β-carotene, soybean oil, Sudan brown, DC Yellow 11, DC Violet 2, DC Orange 5 and quinoline yellow.

The pulverulent compounds can be chosen from pigments and/or pearlescent agents, which may be natural or synthetic, and/or glitter and/or fibres generally used in cosmetic compositions for making up the nails, such as nail varnishes.

The pigments can be white or coloured and inorganic and/or organic. Mention may be made, among these pigments, of carbon black, pigments of D & C type, lakes based on cochineal carmine or on barium, strontium, calcium or aluminium, and guanine.

The term “pearlescent agents” denotes iridescent particles, in particular produced by certain molluscs in their shells or synthesized.

The glitter and/or the fibres can be chosen from those made of materials of acrylic resin, polyester, poly(ethylene terephthalate) or polyurethane type.

The colouring material can be present in a content ranging from 0.01% to 10% by weight with respect to the total weight of the composition.

The proportions are given generally but it is clearly understood that a person skilled in the art will take care that the nature of these compounds and their concentrations do not substantially affect the mirror effect of the first composition.

The second composition of the kit according to the invention can additionally comprise at least one additive chosen from spreading agents, wetting agents, dispersing agents, antifoaming agents, preservatives, UV screening agents, active principles, surfactants, fragrances, neutralizing agents, stabilizing agents and antioxidants.

This second composition is intended more particularly to be used as top coat for the make-up and in particular as nail varnish top coat. However, it can also be employed as base coat. In this case, at least one layer of the first composition is superimposed on it.

The ingredients of the said second composition and their concentrations can be chosen by a person skilled in the art, with the proviso of the conditions mentioned above in order to obtain the desired mirror effect. In particular, these ingredients will be chosen in order for the said second composition to form, after application, a glossy and adherent film which exhibits a satisfactory wear resistance.

The compositions of the present invention can be obtained according to preparation methods conventionally used in cosmetics.

A further subject-matter of the present invention is a method for making up the nails comprising the application, to all or part of the surface to be made up, of at least one layer of the first composition of the kit defined above or of a cosmetic composition for making up the nails as defined above.

Another subject-matter of the present invention is a method for making up the nails comprising the application of at least one layer of each of the two compositions of the kit as defined above.

Generally, at least one layer, indeed even two layers, of the first composition is/are applied, on which at least one layer, indeed even two layers, of the second composition is/are subsequently superimposed. However, it is also possible to reverse the order of superimposition of these compositions, that is to say to favour first the deposition of one or two layers of the second composition as base coat and the consecutive application of one or two layers of the first composition. However, in this specific case, it is desirable to carry out a further application of a layer or of two layers of the second composition at the surface of the metal layer. This method of application, involving superimposition of several layers of two compositions, is particularly advantageous for improving the smoothing of the metal layer and in particular the properties of the make-up thus obtained in terms of gloss and/or of hold.

The first composition can be applied uniformly or non-uniformly, that is to say discontinuously, in particular in the form of symmetrical or asymmetrical geometrical patterns (for example, in the form of dots, squares, rings or stars), distributed in a random or ordered way with clear or blurred outlines on the surface to be made up of the nail.

After application of the first composition, it is preferable to leave a sufficient time until a solid film is obtained before applying the second composition.

The second composition is generally applied uniformly over the surface to be made up, even if it is, however, possible to apply it only to the film formed by the first composition.

In the method of the invention, the said support to be made up is a natural or synthetic nail.

A further subject-matter of the present invention is a made-up support comprising a make-up capable of being obtained by the method defined above. The support is in particular an accessory for making up the nail, in particular a false nail.

The examples given below are given by way of illustration and without being limiting in nature.

### EXAMPLE 1

### Implementational Example of a Nail Varnish

The following compositions are prepared according to conventional methods:

a) Composition for Forming a Base Coat with a Mirror Effect

a) Composition for forming a base coat with a mirror effect

| | | |
|---|---|---|
| Dispersion of aluminium particles sold under the | 40 | g |
| name of Starbrite 1200 EAC ® by Siberline* | | |
| Cellulose acetate butyrate (film-forming agent) | 4 | g |
| Bentone (rheological agent) | 0.5 | g |
| Ethyl acetate (solvent) | q.s. for 100 | g |

*Starbrite 1200 EAC ® is a product comprising 20% by weight of dry matter in 80% of ethyl acetate.

b) Top Coat

b) Top coat

| | | |
|---|---|---|
| Cellulose acetate butyrate (film-forming agent) | 15 | g |
| Ethyl tosylamide (plasticizer) | 3 | g |
| Dimethicone | 0.2 | g |
| Ethyl alcohol | q.s. for 100 | g |

The composition for forming the base coat with a mirror effect is applied continuously, in the form of a monolayer, to nails devoid of make-up. After drying, a make-up film exhibiting a marked mirror effect is obtained.

The second composition is then applied to the film formed by the base coat. After drying, a make-up with a marked mirror effect which is very glossy and which exhibits a satisfactory wear resistance is obtained.

1. Composition for making up the nails, characterized in that it comprises, in a physiologically acceptable medium, particles with a metallic glint in a proportion of greater than or equal to 2% by weight, with respect to the total weight of the composition, and at least one texturizing agent or a mixture of texturizing agents in a proportion of less than or equal to 15% by weight, with respect to the total weight of the composition.

2. Composition for making up the nails, comprising, in a physiologically acceptable medium, particles with a metallic glint, characterized in that said composition is capable of forming a film for which the wear resistance, expressed as loss in weight LW measured according to Standard AFNOR NF T30-015, is greater than 5% by weight, in particular greater than 10% by weight and more particularly greater than 15% by weight.

3. Composition according to claim 2, characterized in that the said particles with a metallic glint are present in a proportion of greater than or equal to 2% by weight with respect to the total weight of the composition.

4. Composition according to anyone of claims 2 and 3, characterized in that it comprises at least one texturizing agent or a mixture of texturizing agents in a proportion of less than or equal to 15% by weight, with respect to the total weight of the composition.

5. Composition according to any one of the preceding claims, characterized in that the total proportion of particles with a metallic glint is greater than or equal to 5% and in particular greater than or equal to 7% by weight with respect to the total weight of the composition.

6. Composition according to any one of the preceding claims, characterized in that the total proportion of particles with a metallic glint is less than or equal to 70%, in particular less than or equal to 20%, by weight and especially less than or equal to 10% by weight with respect to the total weight of the composition.

7. Composition according to any one of the preceding claims, characterized in that the said particles with a metallic glint are chosen from:
particles of at least one metal and/or of at least one metal derivative,
particles comprising a monomaterial or multimaterial and organic or inorganic substrate at least partially covered with at least one layer with a metallic glint comprising at least one metal and/or at least one metal derivative, and
mixtures of the said particles.

8. Composition according to claim 7, characterized in that the said metal is chosen from: Ag, Au, Cu, Al, Zn, Ni, Mo, Cr and their mixtures or alloys.

9. Composition according to claim 7, characterized in that the said metal derivative is chosen from titanium oxides, in particular TiO₂, iron oxides, in particular Fe₂O₃, tin oxides, chromium oxides and the compounds MgF₂, TiCl₄, CrF₃, ZnS, ZnSe, Al₂O₃, MgO, SeO₃, ZrO₂ and MoS₂ and their mixtures or alloys.

10. Composition according to claim 7, characterized in that the said substrate is chosen from metals, metal derivatives, glasses, ceramics, aluminas, silicas, silicates, in particular aluminosilicates and borosilicates, synthetic mica, such as fluorophlogopite, and their mixtures.

11. Composition according to any one of claims 7 to 10, characterized in that the said particles comprising a substrate have a two-layer or multilayer structure.

12. Composition according to any one of the preceding claims, characterized in that the said particles with a metallic glint are flat.

13. Composition according to any one of the preceding claims, characterized in that the said particles with a metallic glint are provided in the form of platelets.

14. Composition according to any one of the preceding claims, characterized in that the said particles with a metallic glint have a shape factor of greater than or equal to 8, in particular of greater than or equal to 10 and, for example, of greater than or equal to 15.

15. Composition according to any one of the preceding claims, characterized in that the said particles with a metallic glint have, according to their greatest dimension, a mean size of less than or equal to 25 μm, in particular of less than or equal to 10 μm and especially of approximately 6 μm.

16. Composition according to any one of claims 1 and 4 to 15, characterized in that the total proportion of texturizing agents is less than or equal to 10% by weight with respect to the total weight of the composition.

17. Composition according to any one of claims 1 and 4 to 16, characterized in that the total proportion of texturizing agents is greater than or equal to 2% by weight, in particular greater than or equal to 5% by weight, with respect to the total weight of the composition.

18. Composition according to any one of claims 1 and 4 to 17, characterized in that the said texturizing agents are chosen from film-forming agents, resins, additional agents which are able to form a film, thickening agents and their mixtures.

19. Composition according to claim 18, characterized in that the said film-forming agent comprises at least one film-forming polymer.

20. Composition according to claim 19, characterized in that the said film-forming polymer is chosen from the group consisting of radical polymers, polycondensates and polymers of natural origin.

21. Composition according to any one of claims 19 and 20, characterized in that the total proportion of film-forming polymer(s) can vary from 0.1 to 15% by weight, in particular from 5 to 10% by weight, and can in particular be less than or equal to 7% by weight, with respect to the total weight of the composition.

22. Composition according to claim 18, characterized in that the said thickening agent is chosen from the group consisting of thickeners for a non-aqueous phase, such as hydrophobic silicas, optionally modified clays and polysaccharide alkyl ethers, and thickeners for an aqueous phase, such as aqueous gelling polymers and clays.

23. Composition according to any one of claims 18 and 22, characterized in that the total proportion of thickening agent(s) is less than or equal to 5%, in particular less than or equal to 2% and especially less than or equal to 1% by weight, with respect to the total weight of the composition.

24. Composition according to any one of the preceding claims, characterized in that it comprises at least one organic solvent medium and/or at least one aqueous medium.

25. Composition according to claim 24, characterized in that the said medium comprises at least one volatile solvent.

26. Composition according to any one of the preceding claims, characterized in that the said composition additionally comprises at least one additive, in particular an additional colouring material chosen from natural or synthetic pearlescent agents, non-metallic pigments, non-metallic particles, natural or synthetic fibres and water-soluble or fat-soluble dyes.

27. Use of a composition as defined according to any one of the preceding claims for forming a base coat in a multilayer make-up.

28. Kit for making up the nails, characterized in that it comprises, in separate containers, a first composition comprising, in a first physiologically acceptable medium, particles with a metallic glint in a proportion of greater than or equal to 2% by weight with respect to the total weight of the first composition, and a second composition, different from the first composition, comprising, in a second physiologically acceptable medium, at least 10% by weight, with respect to the total weight of the second composition, of at least one film-forming agent.

29. Kit according to claim 28, characterized in that the said first composition is as defined in any one of claims 1 and 5 to 26.

30. Kit for making up the nails, characterized in that it comprises, in separate containers, a first composition comprising, in a first physiologically acceptable medium, particles with a metallic glint, the said first composition being capable of forming a film for which the wear resistance, expressed as loss in weight, measured according to Standard AFNOR NF T30-015, is greater than 5% by weight, in particular greater than 10% and more particularly greater than 15% by weight, and a second composition, different from the first composition, comprising, in a second physiologically acceptable medium, at least 10% by weight, with respect to the weight of the second composition, of at least one film-forming agent.

31. Kit according to claim 30, characterized in that the said first composition is as defined in any one of claims 2 to 26.

32. Kit according to any one of claims 20, 29 and 31, characterized in that the said second composition comprises at least 15% by weight with respect to the total weight of the second composition, of film-forming agent(s).

33. Kit according to any one of claims 28 to 32, characterized in that the said second composition additionally comprises at least one thickening agent.

34. Kit according to any one of claims 28 to 33, characterized in that the said second physiologically acceptable medium comprises at least one organic solvent medium and/or at least one aqueous medium.

35. Kit according to any one of claims 28 to 34, characterized in that the said second composition is translucent, semi-transparent or transparent.

36. Kit according to any one of claims 28 to 35, characterized in that the said second composition comprises at least one colouring material chosen from dyes which are soluble in the said second physiologically acceptable medium and pulverulent compounds, such as at least one pigment and/or at least one pearlescent agent and/or at least glitter and/or at least fibres.

37. Kit according to any one of claims 28 to 36, characterized in that the said second composition additionally comprises at least one additive chosen from the group consisting of spreading agents, wetting agents, dispersing agents, antifoaming agents, preservatives, UV screening agents, active principles, surfactants, fragrances, neutralizing agents, stabilizing agents and antioxidants.

38. Method for making up the nails, characterized in that it comprises the application, to all or part of the surface to be made up, of at least one layer of a composition as defined in any one of claims 1 to 26.

39. Method for making up the nails, characterized in that it comprises the application, to the surface to be made up, of at least one layer of each of the compositions of a kit as defined in any one of claims 28 to 37.

40. Make-up method according to claim 38 or 39, characterized in that the surface to be made up is a natural or synthetic nail.

41. Made-up synthetic support comprising a makeup which might be obtained according to the method as defined according to any one of claims 38 to 40.

42. Made-up synthetic support according to claim 41, characterized in that it consists of false nails.
